(19) United States
(12) Patent Application Publication
(10) Pub. No.: US 2026/0225293 A1
(43) Pub. Date: Aug. 6, 2026

(54) METHOD OF AUTOMATED PROCESSING OF HIGH-TEMPERATURE-STABLE, CLOSED-PORE, RIGID HARD FOAMS

(71) Applicant: Evonik Operations GmbH, Essen (DE)

(72) Inventors: Matthias Alexander Roth, Griesheim (DE); Denis Holleyn, Nentershausen (DE); Marcus Peschke, Darmstadt (DE); Uwe Lang, Nieste (DE)

(73) Assignee: Evonik Operations GmbH, Essen (DE)

(21) Appl. No.: 19/147,761

(22) PCT Filed: Jan. 16, 2024
(86) PCT No.: PCT/EP2024/050865

§ 371 Date: Jul. 14, 2025

(30) Foreign Application Priority Data
Jan. 20, 2023 (EP) 23152644.3

(51) Int. Cl. B29C 44/56; B29C 70/02; B29C 70/38; B29C 70/44; B29C 70/48; B29K 105/04; B29K 105/08

(52) U.S. Cl. CPC B29C 44/569; B29C 70/026; B29C 70/38; B29C 70/443; B29C 70/48; B29K 2105/046; B29K 2105/0872

(57) ABSTRACT

A method includes an automated production of lightweight components. The method contains providing a high-temperature-stable, closed-pore, rigid hard foam, providing a fibre reinforcement material, and automated applying of the fibre reinforcement material to the high-temperature-stable, closed-pore, rigid hard foam. The high-temperature-stable, closed-pore rigid hard foam has a Tg of ≥100° C. The lightweight components are aviation and aerospace components. In addition, a production line performs an automated production method for lightweight components.

### FIELD OF THE INVENTION

The invention relates to an automated processing method for high-temperature-stable, closed-pore, rigid hard foams, in particular a production method for composite systems having at least one outer layer and a high-temperature-stable, closed-pore, rigid hard foam as core layer, where the composite systems are suitable for lightweight construction. The invention further relates to a production plant for automated production of lightweight components by processing of high-temperature-stable, closed-pore, rigid hard foams.

### BACKGROUND OF THE INVENTION

In the lightweight construction sector, in particular in aviation and aerospace technology, it is important to use particularly lightweight and robust materials that have a low density and have surfaces that are stable to high and low temperature in the range from about −55° C. to 180° C. in order to meet the demands on a flying object and simultaneously to be able to keep the flying object in the air with minimum energy expenditure. In the field of aviation and aerospace technology, it is advantageous when the materials can withstand a high bending force and a high compressive force.

In order to achieve this aim, as well as hard foams, preference is given to using honeycombs for production of sandwich structures, the structural bionic of which has been adopted from bees' honeycombs. They may be produced from paperboard, resin-impregnated paper, fibre plastic or thin aluminium foils. In aerospace, preference is given to using metal honeycombs, for example aluminium honeycombs. In aviation, preference is given to using resin-impregnated papers or boards that are cured at high temperatures, such that the honeycomb structure is stable at high temperatures of 60 to 180° C.

A sandwich element with honeycomb core (also called honeycomb element) is a three-layer composite construction in sandwich design, consisting of two weight-bearing outer layers and a support core in honeycomb form. The outer layers may consist of board, plastic, fibre composite materials or sheet metal. Various material combinations between support core and outer layers are possible; support core and outer layers are generally bonded to one another.

Since production rates in aviation and aerospace are generally low, the corresponding manufacturing technologies, for example honeycomb prepreg production (production of honeycomb elements with preimpregnated fibres), are based on manual process steps. But in order to shorten production time and process steps, to increase efficiency, to produce a constant quality, to save production costs and to improve the environmental assessment by reduction of material waste and consumption, it would be advantageous to automate the production process for the sandwich structures or for the module required for the flying objects, for example an aircraft or a spacecraft. Moreover, it is possible through the use of innovative manufacturing techniques to achieve new approaches with regard to construction and load.

For honeycomb materials, the first attempts have been made to replace parts of the process with the automated manufacturing technique of automated fibre placement (AFP) in the production of a helicopter side panel.

However, because of the high flexibility and instability of the honeycomb structure and its open pores, it has not been possible to date to automate both the compaction of the honeycomb structure to give a honeycomb sandwich structure and the entire processing operation for production of the sandwich structure, for example commencing with the cutting of the honeycomb material and the repairing of the fringes at the edges, the cutting of the weave, the laying-out of the lower outer layers of the plies, the integration of the core by placing on the honeycomb material, the laying of the upper outer layers, the compacting and the impregnating of the structure with resin. Furthermore, the automation of the handling of honeycomb structures is difficult since honeycomb structures are difficult to grip because of their high flexibility, and the material, after being laid out, does not remain exactly as positioned. Therefore, AFP is possible to date only with honeycomb materials that have already been processed to a sandwich element, and it has been possible to conduct AFP on the outer layers of the honeycomb structure.

Because of the open honeycomb structure, it is not possible to handle the material with a vacuum manipulator. Vacuum manipulators enable particularly gentle handling of the workpieces, a compact and space-saving design of the system, and gripping from above, which enables gapless positioning of the materials. Vacuum manipulators keep the workpiece to be handled on their suckers by virtue of the reduced pressure. The objects require a smooth and continuous surface in order that the air is sucked in and the manipulator can adhere thereto. Since the honeycomb structure has open pores, it is not possible to generate a reduced pressure that enables the vacuum manipulator to hold and to manipulate the honeycomb material.

Other manipulators are likewise unable to solve the problem of automated handling of the honeycomb structure.

Mechanical manipulators are most commonly used in robotics. They may be actuated pneumatically, hydraulically or electrically. This type of device enables precise movements at comparatively low costs. Examples of mechanical manipulators are parallel, angular, radial and three-point grippers. Because of the high flexibility of the honeycomb structure, it is difficult to pick up the material since the structure bends when picked up; it is likewise difficult to precisely position the structure with mechanical manipulators without impairing or shifting the base on which the structure is to be placed.

In the case of mechanical manipulators, a distinction is drawn between permanent and electromagnetic manipulators. In permanently magnetic manipulators, the pickup force is provided by a permanent magnet, and therefore the workpieces have to be “taken off” the manipulator. The electromagnetic manipulator is supplied with electrical DC current that generates the required magnetic field. The ferromagnetic workpieces are picked up and released by switching the power supply on and off. The magnetic pickup form has the same disadvantages in the case of honeycomb structures as the mechanical manipulators. Moreover, before non-magnetic honeycomb structures can be moved with magnetic manipulators, opposing magnets for the manipulator have to be applied to the material, which are in turn difficult to secure since the honeycomb structure has open pores and a securing means can be applied only to the terminal thin ends of the support walls of the honeycomb structure and not over the entire area, and so the adhesion of the magnets can cause problems. Even if the material of the honeycomb structure is magnetic, there can be problems with pickup, since the hollow honeycomb structure means that too small a magnetic interaction can exist between the honeycomb structure and the manipulator.

For sensitive and residue-free pickup, it is also possible to use sticky manipulators. The technology is based on the principle of adhesion and uses intermolecular van der Waals forces for handling. The gripping surface of the grippers has been provided with microscopically small hairs that evolve shear adhesion in the event of pressure onto a surface. Since the adhesion technique, which is gentle on the component, does not require compressed air, reduced pressure or power, the complexity involved in the initial use is comparatively low. However, it is not possible to pick up honeycomb structures with sticky manipulators since the cohesive area is too small because of the open honeycomb structure to be able to build up a sufficient interaction via van der Waals forces.

Honeycomb structures have the further disadvantage that the placing-on and draping of the upper and lower outer layers is difficult because of their structure. The layers can be applied only at the thin ends of the support walls of the honeycomb, and so the securing material becomes detached easily since it cannot be secured over the whole area but only at particular points. Since the securing material cannot be applied over the entire surface area of the honeycomb structure, it is also more likely that air bubbles and other irregularities will occur in relation to the layer material.

Moreover, it is very demanding to apply the bonding means in an automated manner, since, in the case of automatic application, the bonding means is not applied specifically to the edges of the honeycomb structure but is distributed over the entire open area. This firstly has the disadvantage that the material penetrates into the honeycomb structure and hence unnecessarily adds weight to the honeycomb structure; secondly, the edges are not provided specifically with the bonding means, and so there is the risk that the required bonding force of the bonding means will not be achieved.

A further disadvantage is that connecting elements and/or other force introduction elements cannot simply be installed automatically in a fixed manner after the drilling and/or insertion into the honeycomb sandwich structure since they would be unstable for reasons of fraying of the honeycomb structure and owing to the hexagonal cavities of the honeycomb material. If a hole is drilled, the hole has to be backfilled in a controlled manner and fitted to the exact site of material penetration of a connecting element and/or other force introduction elements, and the connecting elements and/or other force introduction elements have to be secured. This leads to an increase in the weight of the honeycomb sandwich structure and to an increase in production costs.

An additional factor is that honeycomb materials, because of their hexagonal honeycomb structure, will fray when cut at the edges, such that they have to be stabilized in accordance with the individual fraying pattern, which complicates an automation process and entails extra work and an increase in weight and production costs.

All these disadvantages complicate automated handling, or make it impossible to date.

The article by Mike Richardson, “Holding out for a hero!”, in Composites in Manufacturing, 19 May 2020, obtainable from https://www.composites.media/holding-out-for-a-hero/category/features, relates to automated manufacturing of sandwich design Rohacell HERO foam fibre composites. The product information “ROHACELL® HERO” from Evonik, April 2022, obtainable from https://performance-foams.evonik.com/en/products-and-solutions/rohacell/rohacell-hero-170036.html, relates to technical properties of ROHACELL® HERO. The product information “ROHACELL® HERO—The Core Material for Aircraft Structures” from Evonik, June 2022, obtainable from https://performance-foams.evonik.com/en/products-and-solutions/rohacell/rohacell-hero-170036.html, relates to tests of sandwich composite aircraft components manufactured with ROHACELL® HERO.

Since production rates in aviation and aerospace are rising, there is a need for a method of automated handling and production of components made from lightweight construction materials. Furthermore, there is a need for a production line for implementation of such a method.

### SUMMARY OF THE INVENTION

The problem that the prior art product production process is unable to meet the actual need is solved in accordance with the invention by a method and a production line according to the present claims.

It has been found that, surprisingly, high-temperature-stable, closed-pore, rigid hard foams can be handled and processed in an automated manner by the method according to the invention, in particular in aviation and aerospace technology.

The method according to the invention has rapid and efficient production steps. In addition, the reproducibility of the lightweight components produced is high and the quality is stable. The automation allows greater amounts of lightweight components to be produced in a short time. The method improves the ecological footprint by at least 20% relative to conventional manual methods. Production waste can be reduced by up to 50%. In addition, a cost saving of up to 40% can be achieved.

### FIGURES

FIG. 1 shows a comparison of the process times of a method according to the invention for automated production of lightweight components with a method of manual production of lightweight components.

### DETAILED DESCRIPTION OF THE INVENTION

The headings in the section that follows serve merely for better readability of the description and should not be regarded as a separation of embodiments from one another.

### Definitions

Unless defined otherwise, the terms used in the present invention have the definitions detailed hereinafter.

First of all, it is pointed out explicitly that, in the context of the present patent application, indefinite articles and numerical statements such as “one”, “two” etc. should generally be understood as “at least” statements, i.e. as “at least one . . . ” , “at least two . . . ” etc., unless it is explicitly apparent from the respective context or obvious to the person skilled in the art or mandatory for technical reasons that this can mean only “exactly one . . . ” , “exactly two . . . ” etc.

In the context of the present patent application, the expression “in particular” should always be understood such that this expression introduces an optional, preferred feature. The expression should not be understood to mean “and this is”, nor to mean “namely”.

The expression “closed-pore foam” used here relates to a foam that has closed pores to an extent of nearly 100%, preferably 50-100%, 75-100%, 80-100%, 85-100%, 90-100%, 95-100%, 99-100% and more preferably 100% of closed pores. The expression “closed-pore” shall be understood to mean that the pores of the foam are closed.

This has the advantage that it is possible to apply a vacuum to the foam. Moreover, the penetration of materials, for example moulding compounds, is reduced, which offers the advantage of producing more lightweight construction materials, for example sandwich structures.

As used here, the word “hard” refers to materials that are not soft or elastic, but firm and durable, barely yielding materials.

The word “rigid” used here relates to flexurally stiff, non-yielding, inflexible, static and inelastic materials having a modulus of elasticity of greater than 0.01 GPa.

The word “prepregs” used here relates to weaves that have been preimpregnated with thermoset or thermoplastic resins. The resins may be applied to the weave in the form of a powder, a melt, a solution or an aqueous dispersion with the weave material.

The term “resin transfer moulding” (RTM) used here relates to a method of producing preforms, in particular sandwich structures. At the start of a cycle, a moulding compound is in an antechamber. First of all, the material to be processed to a preform is placed into a mould which is formed from a first and a second mould, and the mould is closed. The material present in a closed mould is preferably injected or infiltrated with a moulding compound, in particular in the form of resins, with the aid of elevated pressure, and then vulcanized in the closed mould under pressure and temperature for a particular period of time. The moulding compound is injected into the mould from a generally heated antechamber via at least one distributor channel, preferably multiple distributor channels.

If just one distributor channel is used for injection of the moulding compound into the mould, this is called point injection. In the case of point injection, the flow front can trap air, which leads to cavities. If the moulding compound is injected into the mould via multiple distributor channels, this is called multipoint injection. The mould can be more quickly filled with resin via multiple injection points. The positioning of the injection points can prevent the trapping of air. In the case of linear injection, injection is effected not at a point but in a line at the edge of the mould. This may be advantageous in the case of components with a high length ratio, since the flow has to traverse only the shorter edge length. In the case of flow channel injection, the resin is injected through a broad channel above or below the material which is to be shaped to a preform. In the case of cascade injection, multiple injection sites are arranged in the direction of the flow front in order to keep the pressure gradient low. However, it is necessary to open and close the injection conduits along the flow front.

Injection can be effected with the aid of a piston. Depending on the arrangement of the injection piston, there are three fundamental methods. It is is made between the lower piston method (two-piston method) in which the injection piston is below the mould, the upper piston method (one-piston method) in which the injection piston is above the mould, and the horizontal injection piston which generally has a screw pre-plastification unit. The time taken to vulcanize the material or moulding compound depends on various factors, for example the moulding compound, an optional filler, the processing pressure and the temperature. After the vulcanization, the mould can be opened. The previously introduced moulding compound is hardened and firm, and the material in the mould is then referred to as preform. This can then be demoulded from the mould. The excess moulding compound that has remained in the antechamber, also called residual cake, is removed before the start of the new cycle and replaced by new moulding compound. The mould is then cleaned, and a new cycle can begin.

In order to avoid trapped air during the injection operation, the cavity of the mould is generally evacuated with the aid of a vacuum.

The advantages of the RTM method are that a preform is produced with a high laminate quality, the surface of which is smooth and aerodynamic on all sides. Furthermore, the production of a large number of items is possible.

The terms “vacuum infusion method” and “vacuum injection method” relate to a different process for production of preforms similar to the RTM method. In the vacuum infusion method and vacuum injection method, by contrast with the RTM method, only one mould is used, to which a material to be processed to a preform is applied. A vacuum film is placed thereon, and then a moulding compound is infused (vacuum infusion method) or injected (vacuum injection method) into the single-shell mould closed with the vacuum film. In the vacuum infusion method or vacuum injection method, the flowability of the resin is much lower than in the RTM method. The vacuum is preferably generated at about 0.6 to 0.8 bar. The finished part has a smooth surface only on one side, by contrast with the RTM method with closed moulds. The vacuum infusion method and the vacuum injection method are less costly since the costs for the mould are lower.

The moulds used for the RTM method, the vacuum infusion method and the vacuum injection method may be full moulds, soft moulds, mixed moulds (e.g. pipe blowing RTM) or double moulds.

The moulding compounds used for RTM, the vacuum infusion method and vacuum injection method are preferably reactive resins having low viscosity. This keeps the flow resistance slow in the traversing of the mould, and smaller differences in pressure are required for filling. Reactive resins for RTM methods may be specific injection resins consisting of a resin component and a hardener component. Resin systems of low reactivity may be mixed prior to infusion. If highly reactive resin systems are to be used, resin and hardener may be first mixed directly in the infusion line or in the mould. In this way, shorter cycle times are possible. Methods in which the injection resin components are first mixed directly before injection are referred to as RIM (reactive injection moulding) methods. Moulding compounds used may be formaldehyde resins, preferably phenol-formaldehyde (PF) and melamine-formaldehyde (MF), and reactive resins, preferably unsaturated polyester (UP) and epoxy resins (EP), with small filler particles and elastomers.

The term “autoclaving” is understood here to mean a method of pressing fibre composite materials under pressure, which in particular includes fibre reinforcement materials and a high-temperature-stable, closed-pore, rigid hard foam. For this purpose, a pressure vessel closable in a gas-tight manner is used for the thermal treatment of materials in the elevated pressure range, where the vessel comprises a first mould and a second mould that can be hermetically sealed. In the autoclaving, it is customary to generate pressures up to 10 bar and temperatures up to 400° C. Preference is given to applying an internal pressure of at least 8 bar and a temperature between 60 and 250° C. The pressure is applied with the aid of compressors, preferably with a pressure storage means. In the autoclaving, two mould parts are sealed airtight to form a mould after a fibre reinforcement material as lower outer layer, then a high-temperature-stable, closed-pore, rigid hard foam and finally a further fibre reinforcement material as upper outer layer have been applied to the first mould part. The high pressure compresses the individual materials, and the result is a preform in the form of a sandwich structure as fibre composite component. The mould is preferably freed completely of excess air. Fibre composite materials that are formed by the combination of weaves impregnated with synthetic resin, preferably epoxy resin, and high-temperature-stable, closed-pore hard foam are even more preferably cured at a temperature between 100 and 250° C. and within periods between 5 minutes and several hours, depending on the resin and hardener. After the curing, the moulds are cooled down to an internal temperature below 40° C. and transformed to an open position, such that the fibre composite component, or the preform, can be removed.

The term “sheet moulding compounds” (SMC) refers to pastelike moulding compounds in sheet form, composed of thermoset reactive resins and glass fibres, for production of fibre-reinforced polymer composites in the form of sandwich structures. In SMCs, all the necessary components are completely premixed and can be applied in a mould or to a high-temperature-stable, closed-pore, rigid hard foam. Fibre composite materials that are not supplied as sheets are also referred to as bulk moulding compounds (BMC).

The term “automated tape placement” (ATP) used here relates to an automated method of fibre reinforcement of materials. Broad, unidirectional tapes are applied automatically to a material, in particular the high-temperature-stable, closed-pore, rigid hard foam, using a laden roller system which is differently articulated depending on the complexity of the materials to be produced. ATP corresponds essentially to the manual applying of unidirectionally aligned reinforcement fibre tapes, but at higher speeds, with larger parts and with better process control. The end effector handles the tape and deposits it on a surface with the aid of heat and pressure. ATP systems have precise control of the start of the tape, the section and the alignment, such that they are capable of adding more complex reinforcements than the simple addition of additional plies to the material or laminate.

For the production of large parts, for example the outer skin of aircraft wings, generally a single broad tape having a width of 300 mm is used, preferably with a width of up to 150 mm.

The technique is advantageous since it enables precise laying of continuous fibre tapes in order to produce multilayer composite material products that generally have considerable strength.

The term “automated fibre placement” (AFP) used here likewise relates to an automated method of fibre reinforcement of materials. AFP is also referred to as advanced fibre placement. The reinforced materials such as high-temperature-stable, closed-pore, rigid hard foams give a lower weight coupled with the same or higher strength compared to metals. As in the case of ATP, AFP machines lay fibre reinforcements automatically onto moulds or mandrels, but also onto preforms or sandwich structures including high-temperature-stable, closed-pore, rigid hard foams, or directly onto high-temperature-stable, closed-pore, rigid hard foams, and use a number of separate, narrow strands of thermoset or thermoplastic, preimpregnated materials in order to produce composite materials.

In AFP, multiple narrow fibres having a width between 10 and 16 mm, preferably of 3 to 13 mm, more preferably of 8 mm, are used. Because of the lower width of the fibres compared to the tapes in ATP, AFP enables more complex geometries than ATP. Moreover, an AFP machine can cover a surface having a higher degree of curvature than ATP.

AFP is an automated method of producing fibre-reinforced materials in which synthetic resin-preimpregnated nonmetallic fibres are heated and compacted on typically complex mandrels. The fibres are generally introduced in the form of “tows”. A tow is generally a bundle of epoxy resin-impregnated carbon fibres having a width of about 12.7 mm and a thickness of 0.13 mm, present on a spool. Fibre positioning machines (FPM) generally have a capacity of 12 to 32 fibre bundles or, if all fibre bundles are positioned simultaneously in a web, a corresponding web width of 3.81 cm to 10.16 mm. The tapes are fed to a heating and compaction roll at the FPM head and placed across the material surface in webs by means of robotlike machine movements. The webs are preferably laid in the 0°, +45°, −45° and 90° directions in order to form plies, which, in combination, have good properties in all directions. Fibre setting machines are generally rated by weight per unit time.

AFP increases speed and precision in the production of highly developed fibre-reinforced materials. This technology likewise enables better precision and higher laying rates compared to experienced laminators. AFP permits more complex geometries than ATP, but does not achieve the same laying rates as ATP. AFP can be used for production of complex structures that cannot be produced by other automated methods.

Even though AFP systems are generally tailored to the particular use, they all consist of a head with a compacting roll, a fibre supply system, a robot mechanism that holds the head, and a human-machine interface.

AFP machines lay a web of multiple individual narrow tapes by means of a tape-laying head, in order to build up the product. The tapes are supplied to the head via the tape supply system, which accommodates multiple spools holding the tape. The spools preferably have a capacity of about 1000 m of tape per spool.

The tapes are laid precisely by AFP machines according to a computer program which has been defined such that the end product gains the optimal alignment of the fibres on the basis of the expected operational loads of the part to be produced. The tape-laying head is connected to a robot that guides the head into the correct position during the process.

In the last few years, there have been great advances in the optimization of AFP laminations with the aid of simulation software. Simulation software has started to replace the simpler programming software supplied by the machine manufacturers. As a result, the AFP machine can be selected independently of any software. As in the case of computer numerical control (CNC) of processing tools such as drills, lathes and milling machines, it is now possible with AFP to design a part and to simulate its production off-line, for example by means of a software simulation in the AFP machine. Software tools for the construction of composite materials take account of the demands on AFP manufacture even at an early stage of the product development cycle and hence enable direct application to the ultimate manufacturing process.

By comparison with other production methods for fibre-reinforced materials, there are a number of advantages and disadvantages in the use of AFP. Advantages of AFP are the automation of the process, the repeatability and reproducibility of the production, and the low loss of material. Disadvantages are the relatively slow buildup rate since the fibres are very narrow, and the costs for the equipment.

The materials used for AFP and ATP are thermoset and thermoplastic fibres/tape materials. Thermosets, preferably epoxides, are used as polymer matrix for the fibres/tapes in order to bond the fibres to one another during the production process. Use of thermosets has many advantages, including that it is simpler to impregnate the fibres with liquid, there are fewer compatibility problems between thermosets and fibres/tapes, thermosets give better adhesion to the fibres, in particular in the case of epoxides, and they have higher thermal stability.

Thermoplastics, preferably polycaprolactam and polypropylene, have further advantages. They are less expensive than thermosets, have higher impact resistance, have better corrosion resistance than thermosets, give high design flexibility, enable shorter cycle times, permit more reliable handling of the raw material, enable long-term storage of the raw material, have better control of the chemistry, and have better recyclability.

Fibres used for AFP or ATP may be natural textile fibres or synthetic fibres, metal fibres, carbon fibres, glass fibres, polymer fibres or aramid fibres.

The term “weave” used here refers to reinforcing weave that stabilizes the core structure after infiltration with moulding compounds and makes it dimensionally stable.

### Aspects of the Invention

1. Method of automated production of lightweight components, wherein the method comprises the following steps:
a) providing a high-temperature-stable, closed-pore, rigid hard foam;
b) providing a fibre reinforcement material;
c) automated applying of the fibre reinforcement material to the high-temperature-stable, closed-pore, rigid hard foam;

wherein the high-temperature-stable, closed-pore, rigid hard foam has a Tg of ≥100° C., preferably ≥130° C., more preferably ≥180° C.
2. Method according to Aspect 1, wherein the lightweight component is an aviation and aerospace component.
3. Method according to either of Aspects 1 and 2, wherein the method comprises the following steps:
c1) applying the fibre reinforcement material by means of a first manipulator;
c2) laying the fibre reinforcement material by means of the first manipulator as first outer layer in a first mould;
c3) receiving the high-temperature-stable, closed-pore, rigid hard foam by means of the first manipulator or a second manipulator;
c4) applying the high-temperature-stable, closed-pore, rigid hard foam to the first outer layer by means of the first manipulator or the second manipulator;
optionally c5) receiving the fibre reinforcement material by means of the first or a second manipulator and laying the fibre reinforcement material by means of the first or second manipulator as second outer layer in a second mould part or on the high-temperature-stable, closed-pore, rigid hard foam;
c6) compacting the fibre reinforcement material and the high-temperature-stable, closed-pore, rigid hard foam in order to create a sandwich structure composed of fibre-reinforced, high-temperature-stable, closed-pore, rigid hard foam, comprising a first outer layer, a high-temperature-stable, closed-pore, rigid hard foam and optionally a second outer layer, where the first and second outer layers form an upper and lower outer layer that enclose the high-temperature-stable, closed-pore, rigid hard foam.

4. Method according to Aspect 3, wherein the performance of step c1) is preceded by automatic cutting-to-size of the fibre reinforcement material.

5. Method according to either of Aspects 3 and 4, wherein the performance of step c3) is preceded by automatic cutting of the high-temperature-stable, closed-pore, rigid hard foam.

6. Method according to either of Aspects 4 and 5, wherein the performance of step c2) is preceded by movement of the cut fibre reinforcement material by means of a first conveyor belt.

7. Method according to any of Aspects 3 to 6, wherein steps c1) and c2) are repeated, preferably 2-20 times, further preferably 2-15 times, further preferably 2-10 times and more preferably 2-4 times.

8. Method according to any of Aspects 3 to 7, wherein the performance of step c4) is preceded by movement of the high-temperature-stable, closed-pore, rigid hard foam by means of the first or a second conveyor belt.

9. Method according to any of Aspects 3 to 8, wherein the compacting step is conducted by a vacuum infusion method and/or vacuum injection method.

10. Method according to any of Aspects 3 to 8, wherein a sandwich structure composed of fibre-reinforced high-temperature-stable, closed-pore, rigid hard foam is created in step c6), comprising the first outer layer, the high-temperature-stable, closed-pore, rigid hard foam core and the second outer layer, and wherein step c4.1) is conducted after step c4), and wherein step c4.1) comprises receiving fibre reinforcement material according to step c1) and optionally cutting it automatically in a step c1) before the receiving, and applying it by means of the first manipulator as second outer layer in a second mould or to the high-temperature-stable, closed-pore, rigid hard foam, where these steps are preferably repeated, further preferably 2-20 times, further preferably 2-15 times, further preferably 2-10 times and more preferably 2-4 times.

11. Method according to Aspect 10, wherein the compacting step is conducted by resin transfer moulding.

12. Method according to any of Aspects 3 to 11, wherein the fibre reinforcement material comprises a dry weave in the form of a woven fabric, knitted fabric, a fibre, a tape, a scrim in the form of undirected plies or in the form of unidirectional plies, and wherein the fibre reinforcement material preferably comprises natural textile fibres or chemical fibres, metal fibres, carbon fibres, glass fibres, polymer fibres or aramid fibres.

13. Method according to Aspect 10, wherein the compacting step is effected by pressing, wherein the first and second mould serve as pressing media, or by autoclaving, wherein the first and second mould can be sealed hermetically.

14. Method according to any of Aspects 3 to 13, wherein the high-temperature-stable, closed-pore, rigid hard foam is heated before being applied to the lower outer layer or after being applied to the lower outer layer.

15. Method according to either of Aspects 13 and 14, wherein the fibre reinforcement material is a multilayer laminate, a preimpregnated thermoset resin weave and/or a thermoplastic resin weave in the form of a woven fabric, a knitted fabric, a fibre, a tape, a scrim in the form of undirected plies or in the form of unidirectional plies, and wherein the fibre reinforcement material preferably comprises natural textile fibres or chemical fibres, metal fibres, carbon fibres, glass fibres, polymer fibres or aramid fibres, and wherein the resin weave preferably includes formaldehyde resins, preferably phenol-formaldehyde (PF) and melamine-formaldehyde (MF), and reactive resins, preferably unsaturated polyester (UP) and epoxy resins (EP).

16. Method according to any of Aspects 3 to 15, wherein the first, second, third and/or fourth manipulator is a vacuum manipulator which is preferably camera-controlled.

17. Method according to any of Aspects 3 to 16, wherein, as further reinforcement, the fibre reinforcement materials, prior to the introduction of the fibre reinforcement material and the high-temperature-stable, closed-pore, rigid hard foam into a mould, are stitched to the high-temperature-stable, closed-pore hard foam, wherein the stitching is effected automatically after the fibre reinforcement material has been applied to the high-temperature-stable, closed-pore hard foam by means of a manipulator, and/or wherein, as further reinforcement, the high-temperature-stable, closed-pore, rigid hard foam is stitched without weave, and/or wherein, as further reinforcement, the fibre reinforcement material is stitched without high-temperature-stable, closed-pore, rigid hard foam.

18. Method according to either of Aspects 1 and 2, wherein the high-temperature-stable, closed-pore, rigid hard foam is provided, received by a manipulator and processed by automated tape placement (ATP) or automated fibre placement (AFP) to give a sandwich structure composed of fibre-reinforced high-temperature-stable, closed-pore, rigid hard foam.

19. Method according to any of Aspects 3 to 17, wherein the sandwich structure composed of fibre-reinforced closed-pore, rigid high-temperature hard foam is received by a first, second, third, fourth or fifth manipulator and fibre-reinforced by automated tape placement (ATP) or automated fibre placement (AFP).

20. Method according to Aspect 18, wherein the high-temperature-stable, closed-pore, rigid hard foam is cut before being embedded.

21. Method according to any of Aspects 18 to 20, wherein multiple plies, preferably 2-19, further preferably 2-15, further preferably 2-10 and more preferably 2-4, plies of a fibre reinforcement material which is a fibre or a tape are applied to the high-temperature-stable, closed-pore rigid hard foam or the sandwich structure.

22. Method according to any of Aspects 18 to 21, wherein the processing temperature is up to 300° C., up to 250° C., up to 230° C., up to 220° C., up to 200° C., preferably up to 180° C.

23. Method according to any of Aspects 18 to 22, wherein the weaves, fibres or tapes are thermoplastics or thermosets, and wherein the thermoplastics are preferably melted with a laser or a flame.

24. Method according to any of Aspects 1 to 23, wherein the method is monitored by a monitoring system that displays and controls the current method steps and positions of the automation units.

25. Method according to Aspect 24, wherein the monitoring system comprises cameras.

26. Method according to either of Aspects 24 and 25, wherein the monitoring system comprises a programmable logic controller (PLC) and receives global position data from imported CAD data for the components.

27. Method according to any of Aspects 1 to 26, wherein the high-temperature-stable, closed-pore, rigid hard foam comprises polymethacrylimide, polysulfone, polymethylmethacrylate (PMMA), polyurethane (PU), polyvinylchloride (PVC), polyetherimide (PEI), polyetheretherketone (PEEK), polyethylene terephthalate (PET) and/or polyetherketone (PEK), preferably polymethacrylimide and/or polysulfone.

28. Method according to Aspect 27, wherein the high-temperature-stable, closed-pore, rigid hard foam comprises polymethacrylimide having a density of 25 to 330 kg/m³, preferably 20 to 320 kg/m³, more preferably of 25 to 220 kg/m³, even more preferably of 40 to 130 kg/m 3 and especially preferably of 45 to 115 kg/m³.

29. Method according to any of Aspects 1 to 28, wherein the applying of the fibre reinforcement is reversible.

30. Method according to any of Aspects 3 to 29, wherein the sandwich structure has connecting elements and/or other force introduction elements, preferably seams, studs and/or empty tubes.

31. Method according to Aspect 30, wherein the connecting elements and/or force introduction elements consist of plastic and/or metal, preferably aluminium.

32. Method according to either of Aspects 30 and 31, wherein the connecting elements and/or force introduction elements, prior to step c3), are introduced into the high-temperature-stable, closed-pore, rigid hard foam. The high-temperature-stable, closed-pore, rigid hard foam is already provided including the connecting elements and/or force introduction elements.

33. Method according to either of Aspects 30 and 31, wherein the connecting elements and/or force introduction elements are applied to the fibre reinforcement material after step c2) in step c2.1) and/or to the high-temperature-stable, closed-pore, rigid hard foam after step c3) in step c3.1).

34. Method according to either of Aspects 30 and 31, wherein the connecting elements and/or force introduction elements are introduced into the sandwich structure composed of fibre-reinforced high-temperature-stable, closed-pore, rigid hard foam.

35. Method according to any of Aspects 3 to 34, wherein the sandwich structure has an adhesive layer between high-temperature-stable, closed-pore, rigid hard foam and outer layers.

36. Method according to any of Aspects 3 to 34, wherein the sandwich structure does not have an adhesive layer between foam and outer layers.

37. Production line for performance of a method according to any of Aspects 1 to 36.

38. Production line according to Aspect 37, wherein the production line has at least one conveyor belt and at least one manipulator, wherein the production line preferably additionally has at least one mould part.

39. Production line according to either of Aspects 36 and 37, wherein the production line has a monitoring system, wherein the monitoring system has at least one sensor, at least one controller and a display.

40. Production line according to Aspect 39, wherein the sensor is a camera, a light barrier, a pressure sensor and/or a touch sensor.

41. Production line according to either of Aspects 39 and 40, wherein the display is an acoustic and/or visual display, preferably a monitor.

42. Production line according to any of Aspects 39 to 41, wherein the at least one sensor is connected to the controller, and wherein the controller can control the automation method.

43. Production line according to any of Aspects 39 to 42, wherein the display and the controller are connected to one another and the controller can be controlled with the aid of the display.

44. Production line according to any of Aspects 39 to 43, wherein the monitoring system comprises a programmable logic controller (PLC) and receives global position data from imported CAD data for the components.

### Method of Automated Production of Lightweight Components

The problem underlying the present invention is solved by a method of automated production of lightweight components. This method comprises the following steps:
a) providing a high-temperature-stable, closed-pore, rigid hard foam;
b) providing a fibre reinforcement material;
c) automated applying of the fibre reinforcement material to the high-temperature-stable, closed-pore, rigid hard foam.

The high-temperature-stable, closed-pore, rigid hard foam has a Tg of ≥100.0° C., preferably ≥125.0° C., further preferably of ≥130.0° C., further preferably of ≥150.0° C., further preferably of ≥160.0° C., further preferably of ≥170.0° C., further preferably of ≥180.0° C., further preferably of ≥190.0° C., further preferably of ≥200.0° C. The lightweight components are preferably aviation and aerospace components, preferably wings, etc.

The advantage of using high-temperature-stable, closed-pore, rigid hard foams is that these have exact and stable geometry and sufficient compressive strength and thermal stability for automated tape placement (ATP) and automated fibre placement (AFP) lamination methods. The stiffness of the high-temperature-stable, closed-pore, rigid hard foam means that they can be easily handled with the most modern manipulators, and precise pick-and-place operations are possible. High-temperature-stable, closed-pore, rigid hard foams in automated processes have the further advantage that, because of their closed pores, they can be handled with vacuum manipulators on application of reduced pressure. Moreover, it is easily possible to apply opposing magnets for the magnetic manipulator to non-magnetic high-temperature-stable, closed-pore, rigid hard foams, since the opposing magnets stick firmly to the surface because of the closed surface. Closed-pore hard foams, by contrast with honeycomb materials, have a continuous and constant surface, such that microscopically small hairs can evolve shear adhesion and it is possible to use sticky manipulators.

It is easily possible to insert force-bearing elements into the high-temperature-stable, closed-pore, rigid hard foam structure, and it is possible without difficulty to apply laying and securing materials over the entire surface area of the material. Metal sheets can be applied with reduced trapping of air. Moreover, it is possible to conduct the cutting-to-size with a reduced stabilization requirement or entirely without a stabilization process.

The automation of the fibre-plastic processing technology using high-temperature-stable, closed-pore, rigid hard foams allows process times and costs to be reduced considerably by comparison with manual process steps.

Furthermore, because of the strength and stiffness of high-temperature-stable, closed-pore, rigid hard foams, textile reinforcement structures can be directly applied to and draped onto the homogeneous surface in an automated manner with the aid of automation systems/robots/actuators/effectors. Because of the high thermal stability of high-temperature-stable, closed-pore, rigid hard foams, it is also possible to lay out and consolidate preimpregnated fibres, tapes, weaves, scrims etc. with a thermoset and/or thermoplastic matrix, or to activate binders of textiles by fibre/tape placement technology. The stitching technique which is widespread in preform technology can also be used as an additional reinforcement method in production. For this purpose, a needle pierces the high-temperature-stable, closed-pore, rigid hard foam and introduces textile reinforcement structures (e.g. stitching yarn). It is possible here to stitch solely the foam itself and/or else the foam together with the textile outer layers, the fibre reinforcement material. In the subsequent resin infusion methods, the reinforcement structures are then impregnated and consolidated.

Step c) preferably has the following component steps:
c1) applying the fibre reinforcement material by means of a first manipulator;
c2) laying the fibre reinforcement material by means of the first manipulator as first outer layer in a first mould;
c3) receiving the high-temperature-stable, closed-pore, rigid hard foam by means of the first manipulator or a second manipulator;
c4) applying the high-temperature-stable, closed-pore, rigid hard foam to the first outer layer by means of the first manipulator or the second manipulator;
optionally c5) receiving the fibre reinforcement material by means of the first or a second manipulator and laying the fibre reinforcement material by means of the first or second manipulator as second outer layer in a second mould part or on the high-temperature-stable, closed-pore, rigid hard foam;
c6) compacting the fibre reinforcement material and the high-temperature-stable, closed-pore, rigid hard foam in order to create a sandwich structure composed of fibre-reinforced, high-temperature-stable, closed-pore, rigid hard foam, comprising a first outer layer, a high-temperature-stable, closed-pore, rigid hard foam and optionally a second outer layer, where the first and second outer layers form an upper and lower outer layer that enclose the high-temperature-stable, closed-pore, rigid hard foam.

In step c2) and prior to performance of step c6), auxiliaries may be applied to the first outer layer and/or to the high-temperature-stable, closed-pore, rigid hard foam. Auxiliaries here are fillers, dyes and/or flow agents, preferably formaldehyde resins, especially phenol-formaldehyde (PF) and melamine-formaldehyde (MF), and reactive resins, preferably unsaturated polyester resins (UP) and epoxy resins (EP), and polycaprolactam and/or polypropylene.

The applying of the flow agents has the advantage that the fibre reinforcement material is more firmly bonded to the high-temperature-stable, closed-pore, rigid hard foam.

Before step c1), at least one foil and/or at least one membrane may be placed into the first mould; preferably, the at least one foil and/or at least one membrane is positioned by the first manipulator or the second manipulator.

After step c4) and before step c6), at least one foil and/or at least one membrane may be applied to the high-temperature-stable, closed-pore, rigid hard foam by the first manipulator or the second manipulator, or, after step c4) and before step c6), at least one foil and/or at least one membrane may be applied to the optional second outer layer by the first manipulator or the second manipulator.

The applying of the at least one foil and/or at least one membrane has the advantage that the sandwich structure is stabilized, and that the surface of the sandwich structure becomes smoother and hence has better aerodynamic properties.

Manipulators used may be vacuum manipulators, mechanical manipulators, magnetic manipulators and/or sticky manipulators. Preference is given to using vacuum manipulators. Mechanical manipulators may be actuated pneumatically, hydraulically or electrically. In particular, mechanical manipulators may be parallel, angular, radial and three-point grippers. Magnetic manipulators are permanent and/or electromagnetic manipulators.

The advantage of vacuum manipulators is that gripping with the aid of vacuum protects the workpiece from damage, and the construction of the manipulator is space-saving.

Preferably, the performance of step c1) is preceded by automatic cutting-to-size of the fibre reinforcement material. This can be done using a roll cutter, a thread cutter and/or a guillotine. This has the advantage that the fibre reinforcement material is fitted accurately into the first mould.

Further preferably, the performance of step c4) is preceded by automatic cutting of the high-temperature-stable, closed-pore, rigid hard foam. This can be done using a roll cutter, a thread cutter and/or a guillotine. This has the advantage that the high-temperature-stable, closed-pore, rigid hard foam is placed onto the fibre reinforcement material so as to fit accurately into the first mould.

Further preferably, the performance of step c2) is preceded by movement of the cut or uncut fibre reinforcement material by means of a first conveyor belt. The conveyor belt further preferably moves the fibre reinforcement material into a region in which it can be received by the first or second manipulator. The placing on the conveyor belt is effected by means of the first, second or a third manipulator. This has the advantage that the method can be automated further and hence performed at lower cost and more quickly.

Further preferably, steps c1) and c2) are preferably repeated, further preferably 2-20 times, further preferably 2-15 times, further preferably 2-10 times and more preferably 2-4 times. This has the advantage that the outer layer of the sandwich structure gains a higher material thickness and becomes more robust, but at the same time does not become too heavy and still meets the demands of lightweight construction.

Further preferably, the performance of step c3) is preceded by movement of the high-temperature-stable, closed-pore, rigid hard foam by means of the first or a second conveyor belt. The high-temperature-stable, closed-pore, rigid hard foam is conveyed by the first or second conveyor belt into a region in which it can be received by the first or second manipulator. The placing on the conveyor belt can be effected by means of the first, second, third or a fourth manipulator. This has the advantage that the method can be automated further and hence performed at lower cost and more quickly.

Further preferably, the compacting step is conducted by means of a vacuum infusion and/or vacuum injection method. This has the advantage that only the first mould is required and hence the production costs for the sandwich structure are lower.

Preferably, in step c6), a sandwich structure is produced from fibre-reinforced high-temperature-stable, closed-pore, rigid hard foam, comprising the first outer layer, the high-temperature-stable, closed-pore, rigid hard foam core, and the second outer layer. The high-temperature-stable, closed-pore, rigid hard foam core refers to the high-temperature-stable, closed-pore, rigid hard foam which is enclosed by a first and a second outer layer. This enclosure may be continuous or noncontinuous. Step c4.1) is conducted after step c4), where step c4.1) comprises cutting and receiving fibre reinforcement material according to step c1), and applying it by means of the first manipulator as second outer layer in a second mould or to the high-temperature-stable, closed-pore, rigid hard foam, and where these steps are preferably repeated, further preferably 2 to 20 times, further preferably 2 to 15 times, further preferably 2 to 10 times and more preferably 2 to 4 times. This has the advantage that the outer layer of the sandwich structure gains a higher material thickness and becomes more robust, but at the same time does not become too heavy and still meets the demands of lightweight construction.

Preferably, the fibre reinforcement material cut in step c4.1) is moved by means of the first conveyor belt in order to be received by the first manipulator in step c1). Further preferably, a film and/or a membrane is applied to the second outer layer or a film and/or membrane is introduced into the second mould before the fibre reinforcement material is applied into the second mould in step c4.1).

In preferred embodiments of the method according to the invention for production of composite materials in the form of sandwich structures, in an automated process, two outer layers, one upper outer layer and one lower outer layer, are created, and these form a sandwich structure together with the core layer, which is the high-temperature-stable, closed-pore, rigid hard foam. Preferably, the compacting step c6) is conducted by resin transfer moulding. This has the advantage that the sandwich structure is produced with a high laminate quality, the surface of which is smooth and aerodynamic on all sides. Furthermore, the production of a large number of items is possible.

The thickness of the core layer, the high-temperature-stable, closed-pore, rigid hard foam, is preferably in the range from 0.50 to 200.0 mm, especially in the range from 5.0 to 100.0 mm and very preferably in the range from 10.0 to 70.0 mm. The thickness of the outer layers is generally in the range from 0.10 to 100.0 mm, preferably 0.50 to 50.0 mm and more preferably 1.00 to 10.0 mm. The composite material preferably contains more than 30.0% by volume, preferably more than 50.0% by volume and most preferably more than 80.0% by volume of high-temperature-stable, closed-pore, rigid hard foam. Furthermore, the core layer and/or the outer layers may be provided with cutouts, force introduction elements comprising screws, tubes, seams, studs, hooks and/or other inserts. This has the advantage that the lightweight components or the sandwich structures are matched to their future function, and there is no need to undertake alterations to the component after the component has been manufactured. The introduction of tubes has the advantage that cables can be laid through empty pipes, or fluid channels are created. Screws, seams, hooks and studs offer the advantage of a more stable structure and can be used as connecting elements to other components. It is also possible for further layers for bonding or for decorative purposes to be present within the foam core or outside the outer layers.

The fibre reinforcement material is preferably a dry weave in the form of a woven fabric, knitted fabric, fibre, tape, scrim in the form of undirected plies or of unidirectional plies. Further preferably, the fibre reinforcement material comprises natural textile fibres or chemical fibres, metal fibres, carbon fibres, glass fibres, polymer fibres or aramid fibres. This has the advantage that the weave structures have good ability to absorb resins and other flow agents.

The fibre reinforcement material preferably includes auxiliaries in the form of fillers, dyes and/or flow agents. Flow agents are preferably formaldehyde resins, especially phenol-formaldehyde (PF) and melamine-formaldehyde (MF), and reactive resins, preferably unsaturated polyester resins (UP) and epoxy resins (EP), and polycaprolactam and/or polypropylene.

The compacting step c6) is preferably effected by a pressing operation, in which case the first and second moulds serve as pressing means. The compacting step c6) can also be effected by autoclaving, in which case the first and second moulds can be sealed hermetically. The autoclave can be closed after the high-temperature-stable, closed-pore, rigid hard foam and the fibre reinforcement material have been applied, and it is possible to apply an internal pressure of at least 8 bar and a temperature between 60 and 250° C. After the curing process, the autoclave can be cooled down to an internal temperature below 40° C. Then the autoclave can be opened, and the sandwich structure of the fibre-reinforced high-temperature-stable, closed-pore, rigid hard foam can be released.

Preferably, the fibre reinforcement material, in the case of compacting by pressing or autoclaving, comprises a multilayer laminate, a preimpregnated thermoset resin weave or a thermoplastic resin weave in the form of a woven fabric, a knitted fabric, a fibre, a tape, a scrim in the form of undirected plies or of unidirectional plies. The fibre reinforcement material may comprise natural textile fibres or chemical fibres, metal fibres, carbon fibres, glass fibres, polymer fibres or aramid fibres.

The resin weaves preferably include formaldehyde resins, especially phenol-formaldehyde (PF) and melamine-formaldehyde (MF), and reactive resins, preferably unsaturated polyester resins (UP) and epoxy resins (EP). The preimpregnated resin weaves lead to a bond of the fibre composite material to the high-temperature-stable, closed-pore, rigid hard foam during the compaction.

Preferably, the fibre reinforcement material contains 5% to 60% by weight, further preferably 10% to 40% by weight, 20% to 30% by weight or 25% by weight, of fillers and/or dyes.

The advantage of compacting by autoclaving or pressing is that there is no longer any need to in-troduce flow agents into the fibre reinforcement material during the compacting. This leads not only to a reduction in the complexity of the operation but also to reduced trapping of air in the fibre reinforcement material.

The moulding compound in the outer layers can be cured by reversible crosslinking via a hetero-Diels-Alder reaction, in that the moulding compound for this purpose has diene functionalities with a carbon-sulfur double bond and dienophilic double bonds.

Alternatively, the curing of the moulding compound in the outer layers can be effected by reversible crosslinking via a Diels-Alder reaction, in that the polymer formulation for this purpose has dienophilic functionalities that are maleimide groups, and diene functionalities that are furfural, cyclopen-tadienyl and 1,3-pentadienyl groups.

Preferably, the high-temperature-stable, closed-pore, rigid hard foam is heated before being applied to the lower outer layer and/or after being applied to the lower outer layer. Further preferably, the high-temperature-stable, closed-pore, rigid hard foam, before the closing of the press or forming, is heated by means of infrared radiation, near infrared radiation or thermally to a temperature of more than 100° C., and the high-temperature-stable, closed-pore, rigid hard foam is preferably formed directly by pressure during the closing of the press or the autoclave. This has the advantage not only of improved shaping but also that the fibre reinforcement material is better bonded to the high-temperature-stable, closed-pore, rigid hard foam.

Preferably, the first and/or second, further preferably the first, second, third and/or fourth, manipulator is a vacuum manipulator which is preferably camera-controlled. This has the advantage that the surfaces of the materials to be manipulated are gripped in a very material-conserving manner. In addition, camera control can bring about precise receiving and laying of the material to be manipulated, which may be fibre reinforcement material and/or the high-temperature-stable, closed-pore, rigid hard foam.

Preferably, as further reinforcement of the sandwich structure, before the fibre reinforcement material and the high-temperature-stable, closed-pore, hard foam are introduced into a mould, the fibre reinforcement materials are stitched to the high-temperature-stable, closed-pore, hard foam. The stitching is effected automatically after the fibre reinforcement material has been applied to the high-temperature-stable, closed-pore, hard foam by means of a manipulator. Alternatively or sup-plementarily, the stitching is effected as a further reinforcement on the high-temperature-stable, closed-pore, hard foam without fibre reinforcement material.

In a particularly preferred embodiment, the high-temperature-stable, closed-pore, rigid hard foam is provided, received by a manipulator and processed by ATP or AFP to give a sandwich structure composed of fibre-reinforced high-temperature-stable, closed-pore, rigid hard foam.

In AFP, a laying head is preferably mounted on a conventional 6-axis robot in order to lay continuous fibre-reinforced material in the form of several tows simultaneously onto a mould. The degrees of freedom of a robot-based AFP system enable the laying of complex 3D components in a mesh.

AFP has the advantage that it increases speed and precision in the production of highly developed fibre-reinforced materials. Moreover, AFP offers the advantage that it can be used for production of complex structures that cannot be produced by other automated methods. Furthermore, it offers reproducibility of production and low material loss.

Preferably, the sandwich structure composed of fibre-reinforced high-temperature-stable, closed-pore, rigid hard foam that has been produced by one of the methods described in this application is received by the first, second, third, fourth or a fifth manipulator and fibre-reinforced by ATP and/or AFP. This offers the advantage of further reinforcement of the sandwich structure. It is additionally advantageous since the fibre reinforcement of the sandwich structure by AFP and/or ATP means that complex geometries can be applied to the sandwich structure.

The accuracy of the automatic positioning is ±0.10 mm, and hence exceeds the precision requirements in the aviation sector by more than a factor of two.

Preferably, AFP and ATP is planned and controlled with simulation software. The planning can be conducted offline. Alternatively, the AFP and/or ATP method is conducted by computer numerical control (CNC). Simulation software for the construction of composite materials takes account of the demands on AFP manufacture even at an early stage of the product development cycle and hence enables direct application to the ultimate manufacturing process.

Preferably, the high-temperature-stable, closed-pore hard foam is cut prior to reinforcement with fibre reinforcement materials by AFP and/or ATP. This can be done using a roll cutter, a thread cutter and/or a guillotine. This has the advantage that the sandwich structure is cut to size for an accurate fit depending on the requirement for the component before the reinforcing of the sandwich structure.

Preferably, the ATP or AFP applies multiple plies, further preferably 2-20, further preferably 2-15, further preferably 2-10 and more preferably 2-4 plies, of the fibre reinforcement material to the high-temperature-stable, closed-pore, rigid hard foam or to the sandwich structure.

Further preferably, the processing temperature in ATP or AFP is up to 300° C., up to 250° C., up to 230° C., up to 220° C., up to 200° C., preferably up to 180° C.

Further preferably, the fibre reinforcement material applied by the AFP and/or ATP method includes thermoplastics or thermosets and/or weaves, fibres or tapes that have been preimpregnated with thermoset or thermoplastic resins. The thermoplastics are preferably melted by a laser or a flame.

In the preimpregnated weaves, fibres or tapes according to the present invention, the resins may be applied to the weave in the form of a powder, a melt, a solution or an aqueous dispersion. Thermosets may be provided as sheet moulding compounds (SMC) or bulk moulding compounds (BMC). Preference is given to using polyester or vinyl ester resins.

Further preferably, the method is monitored by a monitoring system that displays and controls the current method steps and positions of the automation units. The automation units are all units that act automatically, especially conveyor belt, manipulator, AFP and ATP machines, autoclave, press, RTM apparatus, vacuum injection and vacuum infusion apparatus.

The monitoring system preferably comprises cameras. Further preferably, the monitoring system comprises a programmable logic controller (PLC) and receives global position data from imported CAD data for the components. Further preferably, new assembly situations can be adjusted by rapid preliminary measurement with a laser tracker. This has the advantage of resulting in a reliable process and high positioning accuracy. Apart from the pressing of the start button, the method proceeds automatically. The user interface with self-explanatory pictures can be made user-friendly in order to facilitate input.

Preferably, the high-temperature-stable, closed-pore, rigid hard foam comprises polymethacrylimide, polysulfone, polymethylmethacrylate (PMMA), polyurethane (PU), polyvinylchloride (PVC), polyetherimide (PEI), polyetheretherketone (PEEK) and/or polyetherketone (PEK), preferably polymethacrylimide and/or polysulfone.

High-temperature-stable, closed-pore, rigid hard foams such as polymethacrylimide (PMI) or polysulfone foams have high stiffness coupled with low weight. This intrinsic stiffness is relevant for gripping and for mechanical processing. The materials additionally remain where they were placed in the course of laying.

Polymethacrylimide is one of the polyimides. A copolymer of methacrylic acid and acrylonitrile is transformed to polymethacrylimide by foaming at 170-250° C. Hard PMI plastic and hard PMI foam have high thermal stability with a glass transition temperature (Tg) of at least 180° C., are creep-resistant and stable to sustained vibration, and are notable for high stiffness, a homogeneous, closed-pore foam structure and easy formability.

In hard PMI foams, the pore structure of the polymer can be altered by a specific production method so as to result in different strength values in the longitudinal plane and at right angles thereto.

PMI foams are normally produced in a two-stage method: a) production of a cast polymer and b) foaming of that cast polymer. The foaming can also be effected in two or more separate stages. For example, it is possible to cover preformed foam cores with outer layers and then to continue the foaming process. The production of such PMI foams is known in general to the person skilled in the art and is described, for example, in patents EP 1 444 293, EP 1 678 244 and WO 2011/138060. PMI foams include in particular ROHACELL® products from Evonik Industries AG. Acrylimide foams should be regarded as analogues of PMI foams with regard to production and processing. For toxicological reasons, however, they are less preferable compared to other foams. The requisite foam cores can be produced by means of a suitable selection of glass plates in a bulk polymerization or by means of production by in-mould foaming. In an alternative, the products are produced from foamed sheets by cutting-out, sawing or milling. It is preferably possible to cut several foam parts out of one sheet. The density of the hard foam can be selected relatively freely. It is possible to use, for example, PMI foams within a density range from 25.0 to 330.0 kg/m³. The advantage of sawn, cut or machined foam core pieces over those produced by in-mould forming is that they have open pores at the surface. When they come into contact with the resin-saturated fibres, some of the as yet unhardened resin penetrates into said open pores in the foam core surface. This has the advantage that hardening achieves particularly strong adhesion at the boundary between foam core and cladding material. As an alternative to the PMI foam cores described, it is also possible in accordance with the invention to use different hard foam cores. Foams of this kind are common knowledge to those skilled in the art. Examples of such alternative hard foams are especially polymethylmethacrylate (PMMA) or highly crosslinked polyurethane (PU) foams.

Polysulfones such as polysulfone (PSU), polyethersulfone (PES) and polyphenylenesulfone (PPSU) can be used within a temperature range from −100.0° C. to +200.0° C. They are composed of para-linked aromatics, of sulfone and ether groups, and in some cases also of alkyl groups.

Polysulfones have excellent heat and oxidation stability, hydrolysis stability with respect to aqueous and alkaline media, and good electrical properties. They have one of the highest operating temperatures of all thermoplastics that can be processed from the melt. Their stability at high temperatures enables use as flame retardant without any deterioration in mechanical properties.

Polysulfones can be reinforced with glass fibres. The resulting composite material has twice the tensile strength and three times the modulus of elasticity.

Because of the closed-pore structure and high intrinsic stiffness, the disadvantages described for honeycomb materials are not applicable to the high-temperature-resistant, closed-pore, rigid hard foams such as polymethacrylimide (PMI) or polysulfone foams. They may be taken up, manipulated and laid in an automated manner with any type of manipulator, especially vacuum, mechanical, magnetic or sticky manipulators. They can be easily taken up by manipulators and can be positioned precisely since the foams are rigid. The material does not bend when gripped, and can be positioned precisely with manipulators without impairment or movement of the base on which the structure is to be placed.

Preferably, the high-temperature-stable, closed-pore, rigid hard foam comprises polymethacrylimide having a density of 20 to 330 kg/m³, preferably 25 to 320 kg/m³, more preferably of 40 to 220 kg/m³ and especially preferably of 45 to 130 kg/m³.

This has the advantage that the high-temperature-stable, closed-pore, rigid hard polymethacrylimide foam has good mechanical properties, pressure stability on compaction, and exceptional strength.

The applying of the fibre reinforcement is preferably reversible. This has the advantage that the sandwich structure is recyclable, and can be modified for other uses.

The lightweight component preferably has connecting elements and/or other force introduction elements, preferably seams, studs and/or empty tubes. In particular, the sandwich structure preferably has connecting elements and/or other force introduction elements, preferably seams, studs and/or empty tubes. Cables can be pulled through the empty tubes. Preferably, the connecting elements and/or force introduction elements comprise or consist of plastic and/or metal, preferably aluminium.

Further preferably, the connecting elements and/or force introduction elements are introduced into the high-temperature-stable, closed-pore, rigid hard foam prior to step c3). The high-temperature-stable, closed-pore, rigid hard foam is already provided including the connecting elements and/or force introduction elements.

Additionally or alternatively, the connecting elements and/or force introduction elements are applied to the fibre reinforcement material after step c2) in step c2.1) and/or to the high-temperature-stable, closed-pore, rigid hard foam after step c3) in step c3.1).

Moreover, the connecting elements and/or force introduction elements are additionally or alternatively introduced into the sandwich structure composed of fibre-reinforced high-temperature-stable, closed-pore, rigid hard foam.

Preferably, the sandwich structure has a bonding layer between foam and outer layers, or the sandwich structure has no bonding layer between foam and outer layers.

Preferably, the fibre reinforcement material which is applied as second outer layer to the high-temperature-stable, closed-pore, rigid hard foam or to the second mould is cut automatically by a manipulator before being taken up and applied. This can be done using a roll cutter, a thread cutter and/or a guillotine. This has the advantage that fibre reinforcement material is placed onto the high-temperature-stable, closed-pore, rigid hard foam or into the second mould so as to fit accurately.

Furthermore, the problem underlying the present invention is solved by a production line for performance of a method described above.

Preferably, the production line has at least one conveyor belt and/or at least one manipulator, where the production line preferably additionally has at least one mould part or an AFP and/or ATP apparatus.

Further preferably, the production line has a monitoring system, wherein the monitoring system has at least one sensor, at least one controller and a display. This has the advantage that the production line can automatically control and monitor a production process. The production line can be monitored here via the display by a human or robot. In particular, the monitoring system preferably is configured to display and control the current method steps and positions of the automation units in a method of the invention.

The sensor is preferably a camera, a light barrier, a pressure sensor and/or a touch sensor.

Further preferably, the display is an acoustic and/or visual display, preferably a monitor.

Further preferably, the at least one sensor is connected to the controller, where the controller can control the automation method.

Further preferably, the display and the controller are connected to one another, and the display can be used to control the controller.

Preferably, the monitoring system comprises a programmable logic controller (PLC) and receives global position data from imported CAD data for the components.

### Examples

### Example 1—Process Time of Manual and Automated Production

In Example 1, a method of automated production of lightweight components according to the present invention was compared with a method of manual production of lightweight components with regard to process times. For this purpose, the times of individual method steps of the method of automated production of lightweight components was compared with times of individual method steps for manual production of lightweight components. The compared method steps were the cutting of preimpregnated fibres (cutting prepreg), production of the high-temperature-stable, closed-pore, rigid hard foam (core preparation), preform patches, the laying of the fibre composite material as the first outer layer (lay-up outer skin), the laying of the high-temperature-stable, closed-pore, rigid hard foam (core integration), and the laying of the fibre composite material as the second outer layer (lay-up inner skin).

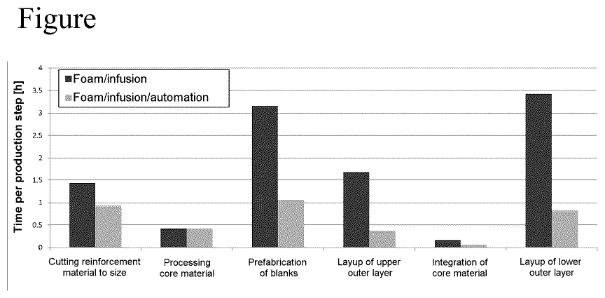

The result of the comparison is shown in FIG. 1. The automated method saves a total of 37% process time with the compared method steps. The automated method of cutting the preimpregnated fibres saves about 64% of the process time compared to the manual method of cutting the preimpregnated fibres. The production of the high-temperature-stable, closed-pore, rigid hard foam takes roughly the same amount of time for the method of automated production of lightweight components and the method of manual production of lightweight components. The method of automated production of lightweight components, compared to the method of manual production of lightweight components, saves 66% of the process time for the method step of preform patches, 67% for the method step of the laying of the high-temperature-stable, closed-pore, rigid hard foam, and 76% for the laying of the fibre composite material as the second outer layer.

1. A method of automated production of lightweight components, the method comprising:
a) providing a high-temperature-stable, closed-pore, rigid hard foam;
b) providing a fibre reinforcement material;
c) automated applying of the fibre reinforcement material to the high-temperature-stable, closed-pore, rigid hard foam;
wherein the high-temperature-stable, closed-pore, rigid hard foam has a Tg of ≥100° C.; and
wherein the method is monitored by a monitoring system that displays and controls the current method steps and positions of an automation unit.

2. The method according to claim 1, wherein the high-temperature-stable, closed-pore, rigid hard foam has a Tg of ≥130° C.,

3. The method according to claim 1, wherein the lightweight components are aviation and aerospace components.

4. The method according to claim 1, wherein c) comprises
c1) applying the fibre reinforcement material by a first manipulator;
c2) laying the fibre reinforcement material by the first manipulator as first outer layer in a first mould part;
c3) receiving the high-temperature-stable, closed-pore, rigid hard foam by the first manipulator or a second manipulator;
c4) applying the high-temperature-stable, closed-pore, rigid hard foam to the first outer layer by the first manipulator or the second manipulator;
optionally c5) receiving the fibre reinforcement material by the first or a second manipulator and laying the fibre reinforcement material by the first or second manipulator as second outer layer in a second mould part or on the high-temperature-stable, closed-pore, rigid hard foam;
c6) compacting the fibre reinforcement material and the high-temperature-stable, closed-pore, rigid hard foam in order to create a sandwich structure comprising a first outer layer, a high-temperature-stable, closed-pore, rigid hard foam and optionally a second outer layer, where the first and second outer layers form an upper and lower outer layer that enclose the high-temperature-stable, closed-pore, rigid hard foam.

5. The method according to claim 4, comprising:
conducting the compacting by a vacuum infusion method and/or vacuum injection method.

6. The method according to claim 4, comprising:
creating in c6), a sandwich structure by compacting, comprising the first outer layer, the high-temperature-stable, closed-pore, rigid hard foam core and the second outer layer, and
conducting c4.1) after c4), and wherein c4.1) comprises receiving the fibre reinforcement material according to c1) and optionally cutting it automatically before c1), and applying it by the first manipulator as second outer layer in a second mould part or to the high-temperature-stable, closed-pore, rigid hard foam.

7. The method according to claim 6, comprising:
conducting the compacting in c6) by resin transfer moulding.

8. The method according to claim 6, comprising:
effecting the compacting in c6) by pressing, wherein the first and second mould parts serve as pressing media, or by autoclaving, wherein the first and second mould parts are configured to be sealed hermetically.

9. The method according to claim 4, wherein the first and/or second manipulator is a vacuum manipulator.

10. The method according to claim 1, comprising:
providing the high-temperature-stable, closed-pore, rigid hard foam, receiving the high-temperature-stable, closed-pore, rigid hard foam by a manipulator, and
processing the high-temperature-stable, closed-pore, rigid hard foam by automated tape placement (ATP) or automated fibre placement (AFP) to give a sandwich structure composed of fibre-reinforced high-temperature-stable, closed-pore, rigid hard foam.

11. The method according to claim 4, comprising:
receiving the sandwich structure composed of fibre-reinforced high-temperature-stable, closed-pore, rigid hard foam by a first, second or third manipulator, and fibre-reinforcing by automated tape placement (ATP) or automated fibre placement (AFP).

12. The method according to claim 1, wherein the monitoring system comprises cameras.

13. The method according to claim 1, wherein the monitoring system comprises a programmable logic controller (PLC) and receives global position data from imported CAD data for the components.

14. The method according to claim 1, wherein the high-temperature-stable, closed-pore, rigid hard foam comprises polymethacrylimide, polysulfone, polymethylmethacrylate, polyurethane, polyvinylchloride, polyethylene terephthalate, polyetherimide, polyetheretherketone and/or polyetherketone.

15. The method according to claim 14, wherein the high-temperature-stable, closed-pore, rigid hard foam comprises polymethacrylimide having a density of 20 to 330 kg/m³.

16. The method according to claim 4, wherein the sandwich structure has connecting elements.

17. A production line for performance of a method according to claim 1, wherein the production line has a monitoring system, wherein the monitoring system has at least one sensor, at least one controller and a display, and wherein the monitoring system is configured to display and control the current method steps and positions of the automation unit in the method.
